(19) United States
(12) Patent Application Publication
(10) Pub. No.: US 2014/0191939 A1
(43) Pub. Date: Jul. 10, 2014

(54) USING NONVERBAL COMMUNICATION IN DETERMINING ACTIONS

(71) Applicant: MICROSOFT CORPORATION, Redmond, WA (US)

(72) Inventors: Daniel J. Penn, Woodinville, WA (US); Mark Hanson, Woodinville, WA (US); Robert Chambers, Sammamish, WA (US); Elizabeth Shriberg, Berkeley, CA (US)

(73) Assignee: MICROSOFT CORPORATION, Redmond, WA (US)

(21) Appl. No.: 13/737,542

(22) Filed: Jan. 9, 2013

(51) Int. Cl. G06F 3/01

(52) U.S. Cl. CPC G06F 3/01
USPC 345/156

(57) ABSTRACT

Nonverbal communication is used when determining an action to perform in response to received user input. The received input includes direct input (e.g. speech, text, gestures) and indirect input (e.g. nonverbal communication). The nonverbal communication includes cues such as body language, facial expressions, breathing rate, heart rate, well as vocal cues (e.g. prosodic and acoustic cues) and the like. Different nonverbal communication cues are monitored such that performed actions are personalized. A direct input specifying an action to perform (e.g. “perform action 1”) may be adjusted based on one or more indirect inputs (e.g. nonverbal cues) received. Another action may also be performed in response to the indirect inputs. A profile may be associated with the user such that the responses provided by the system are determined using nonverbal cues that are associated with the user.

### BACKGROUND

Verbal communication and other direct inputs may be used in a variety of different applications. For example, speech input and other direct input methods may be used when interacting with a productivity application, a game, and/or some other application. These systems may use different types of direct input, such as speech, text and/or gestures received from a user. Creating a system that interprets and responds to the users direct input can be challenging.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Nonverbal communication (e.g. not words themselves but behavior and elements of speech) is used when determining an action to perform in response to received user input. The received input includes direct input (e.g. speech, text, gestures) and indirect input (e.g. nonverbal communication). The nonverbal communication includes cues such as body language, facial expressions, breathing rate, heart rate, well as vocal cues (e.g. prosodic and acoustic cues) and the like but not the words themselves. Different nonverbal communication cues are monitored such that performed actions are personalized. A direct input specifying an action to perform (e.g. “perform action 1”) may be adjusted based on one or more indirect inputs (e.g. nonverbal cues) received. Another action may be performed in response to the indirect inputs. For example, if the nonverbal cues indicate frustration with an action performed, a modified action may be performed and/or clarification may be requested from the user. A profile may be associated with the user such that the responses provided by the system are determined using nonverbal cues that are associated with the user. For example, a profile for a first user may indicate that the user typically leans forward and is very loud, whereas a profile for a second user indicates that the second user is quiet (e.g. rarely loud). An action performed for the second user may be adjusted based on the second user becoming loud, whereas a performed action for the first user may not be adjusted when the first user is loud since the first user's profile indicates that they are typically loud.

### BRIEF DESCRIPTION OF THE DRAWINGS

FIG. 1 shows a system for using nonverbal communication to determine an action to perform in a conversational system;

FIG. 2 shows an illustrative process for using nonverbal communication with direct communication to determine an action to perform;

FIG. 3 shows exemplary nonverbal communication cues that may be used as indirect input;

FIG. 4 illustrates an exemplary system for using nonverbal communication; and

FIGS. 5-7 and the associated descriptions provide a discussion of a variety of operating environments in which embodiments of the invention may be practiced.

### DETAILED DESCRIPTION

Referring now to the drawings, in which like numerals represent like elements, various embodiment will be described.

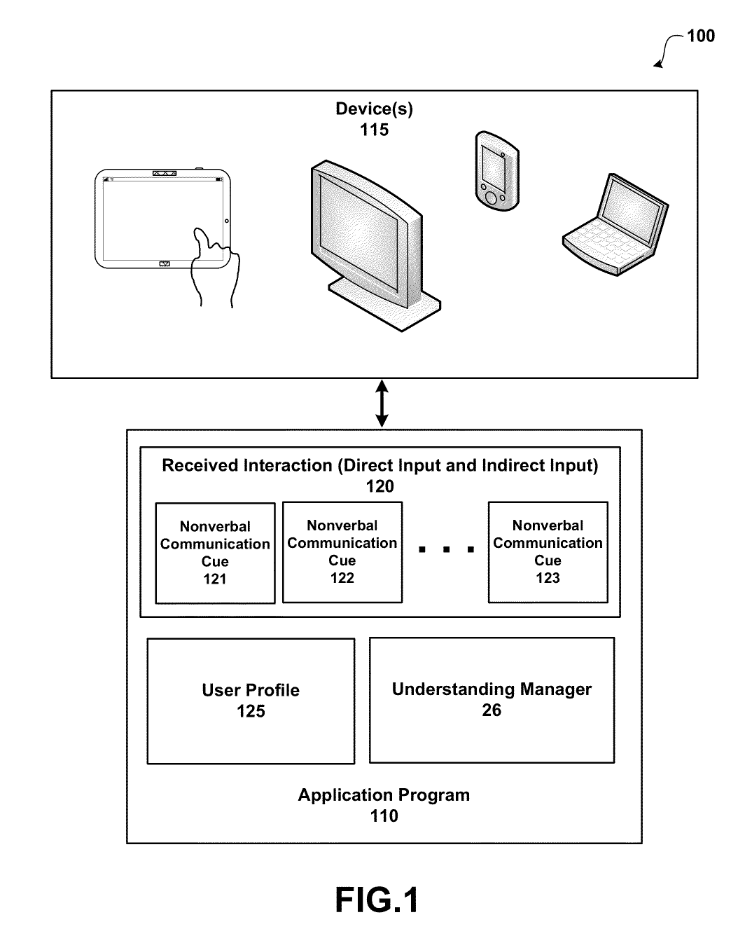

FIG. 1 shows a system for using nonverbal communication to determine an action to perform. As illustrated, system 100 includes application program 110, understanding manager 26, user profile 125, received interaction 120, nonverbal communication cues 121-123, and device(s) 115.

In order to facilitate communication with the understanding manager 26, one or more callback routines, may be implemented. According to one embodiment, application program 110 is a productivity application, such as included in the MICROSOFT OFFICE suite of applications, that is configured to receive user interaction. The application program 110 may be configured to interact with/operate on one or more different computing devices (e.g. a slate/tablet, a desktop computer, a touch screen, a display, a laptop, a mobile device, . . . ). The user interaction may be received using one or more different sensing devices. For example, the sensing device(s) may include a camera, a microphone, a motion capture device (e.g. MICROSOFT KINECT), a touch surface, a display, sensing devices (e.g. heart, breath, . . . ) and the like.

The user interaction comprises direct input (e.g. specific words, gestures, actions) and indirect input (e.g. nonverbal communication such as nonverbal communication cues 121-123). The user interaction may include interactions such as: voice input, keyboard input (e.g. a physical keyboard and/or SIP), video based input, and the like.

Understanding manager 26 may provide information to application 110 in response to the interaction including the direct input and indirect input. Generally, nonverbal communication includes any form of detected communication that captures how something is communicated without the use of direct communication (e.g. words, predefined gestures, text input, . . . ). The nonverbal communication may be used to affirm a direct communication and/or disaffirm the direct communication. Nonverbal communication is used often in communication. For example, when a user becomes upset, the user's voice may become louder and/or change tone. The user's physical characteristics may also change. For example, a user's heart rate/breathing rate may increase/decrease, their facial expression, body movement, posture and the like may change depending on the situation (e.g. a user may lean forward to show attentiveness, show a look of disgust to show dissatisfaction, . . . ).

In some examples, direct input may conflict with the detected nonverbal communication. For example, a user may state that they like a set of results, but their nonverbal communication indicates a weakened level of satisfaction (e.g. angry tone detected).

Understanding manager 26 is configured to determine an action to perform in response to received user input/interaction. As mentioned, the received interaction includes direct input (e.g. speech, text, gestures) and indirect input (e.g. nonverbal communication). The nonverbal communication includes cues such as body language, facial expressions, breathing rate, heart rate, well as vocal cues and the like. As used herein, vocal cues comprise: Intonation (pitch) cues: level, range, and contours over time; Loudness (energy) cues: level, range, and contours over time; Duration pattern cues: timing of speech and silent regions, including latency pauses (time between machine actions and user's speech); and Voice quality cues: spectral and acoustic features of voice timbre (indicating vocal effort, tension, breathiness, roughness).

Different nonverbal communication cues are received and/or monitored by understanding manager 26. Understanding manager 26 may modify a direct input specifying an action to perform (e.g. “perform action 1”) based on one or more indirect inputs (e.g. nonverbal cues) received/detected. Another action may also be performed by the understanding manager 26 in response to the indirect inputs. For example, if the nonverbal cues indicate frustration with an action performed, understanding manager 26 may perform a modified action may be performed and/or clarification may be requested from the user.

A profile (user profile 125) may be associated with each user such that the actions/responses that are determined using nonverbal cues are determined using nonverbal communication behavior that relates to the user. Each user generally exhibits different nonverbal communication behavior. For example, a profile for a first user may indicate that the user typically leans forward and is very loud, whereas a profile for a second user indicates that the second user is quiet (e.g. rarely loud). An action performed for the second user may be adjusted by understanding manager 26 based on the second user becoming loud, whereas a performed action for the first user may not be adjusted when the first user is loud since the first user's profile indicates that they are typically loud. More details are provided below.

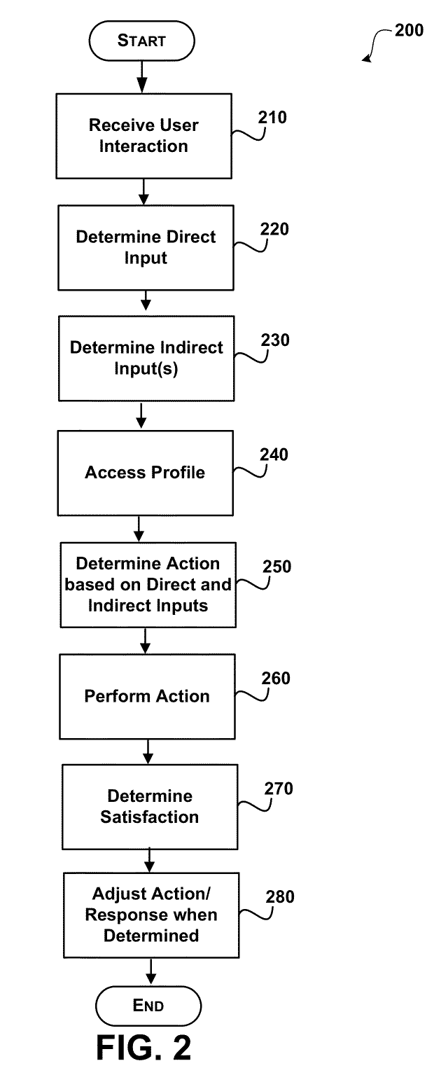

FIG. 2 shows an illustrative process 200 for using nonverbal communication with direct communication to determine an action to perform. When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated and making up the embodiments described herein are referred to variously as operations, structural devices, acts or modules. These operations, structural devices, acts and modules may be implemented in software, in firmware, in special purpose digital logic, and any combination thereof.

After a start operation, the process moves to operation 210, where user interaction is received. The user interaction may comprise different forms of interaction, such as speech, touch, gesture, text, mouse, and the like. For example, a user may say a command and/or perform some other input (e.g. an associated gesture with the input). The user interaction may be received using one or more different devices. For example, the devices may include a camera, a microphone, a motion capture device (e.g. MICROSOFT KINECT), a touch surface, a display, sensing devices (e.g. heart, breath, . . . ) and the like. The user interaction comprises direct input (e.g. specific words, gestures, actions) and indirect input (e.g. nonverbal communication).

Flowing to operation 220, the direct input from the user interaction is determined. The direct input may be a speech input that requests an application/system to perform an action, a gesture (e.g. a specific body movement), a touch gesture (e.g. using a touch device), textual input, and the like. The direct input is the specific word/command that is associated with the user interaction.

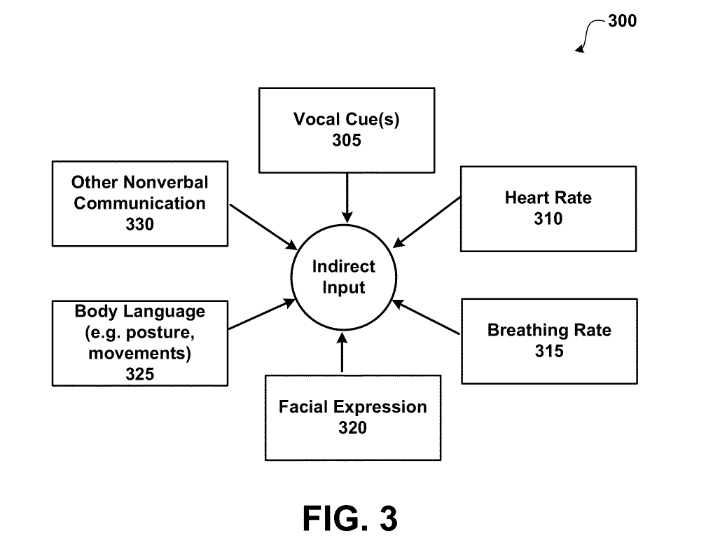

Moving to operation 230, indirect input(s) are determined. The indirect inputs that are monitored/detected by may include a variety of different nonverbal communication cues. For example, the nonverbal communication cues may include one or more of vocal cues, heart rate, breathing rate, facial expression, body language and the like (See FIG. 3 and related discussion). The indirect input may be used to confirm the direct input and/or modify the direct input and/or perform one or more other actions.

Transitioning to operation 240, a profile that is associated with the user performing the interaction is accessed. According to an embodiment, the profile includes nonverbal communication cues/information that is associated with the user. The profile may include a baseline profile of the nonverbal communication cues generally used by the user. For example, the profile may include a normal heart rate, breathing rate, posture, facial expression and vocal cues that are associated with a user. Each user's nonverbal cues may be different. For example, one user may always sit up and talk in a monotone voice, whereas another user typically slouches and speaks loudly. The nonverbal cues that are included in the profile are used in determining when there are changes in a user's nonverbal communication.

Flowing to operation 250, an action to perform is determined using the direct input and the indirect input. For example, a user may use a speech input to indicate an action to perform, but their nonverbal communication indicates hesitation/doubt. These nonverbal cues may be used to modify the action to perform and/or request further input from the user (e.g. asking for confirmation, changing questions, . . . .) For example, a voice of the system may change (adaptive voice response) based on a level of anger/happiness detected from the nonverbal communication of the user. Different paths/approaches may also be taken in response to the detected level of satisfaction. A user interface may also be modified (adaptive UI response) in response to the detected nonverbal communication. For example, a help screen may be displayed when it is detected that the user is uncertain of an action. As another example, during a game (or some other application) the nonverbal communication (e.g. heart rate, breathing, excitement, . . . ) may be used to change an intensity of the game.

Moving to operation 260, the determined action is performed.

Transitioning to operation 270, a satisfaction associated with the user is determined in response to performing the action. According to an embodiment, nonverbal communication is monitored to determine the user satisfaction without using/requesting direct input. For example, after performing a search and returning results, nonverbal communication detected from the user may indicate dissatisfaction/satisfaction with the results.

Moving to operation 280, actions/responses may be adjusted based on the determined satisfaction. For example, a voice of the system (e.g. a calming voice) may change (adaptive voice response) when it is determined that a user is frustrated or angry compared to when it is determined that the user is satisfied and/or happy. Different paths/approaches may also be taken in response to the detected level of satisfaction. For example, questions may be changed to assist the user (e.g. simpler closed-ended questions may be more helpful to step user through the interaction as compared to the standard questions). The user interface may also be modified (adaptive UI response) in response to the determined user satisfaction. For example, the number of search results displayed on the screen could be changed by possibly displaying more results when it is detected that they are dissatisfied with previous results. Similarly, if it is determined from the nonverbal communication that the user seems unsure of what the system is asking or if they show signs of uncertainty (e.g., shrug their shoulders) the system may respond with a different question(s).

The process then moves to an end operation and returns to processing other actions.

FIG. 3 shows exemplary nonverbal communication cues that may be used as indirect input.

Nonverbal communication includes the detected communication that is not a form of direct communication (e.g. words, predefined gestures, text input, . . . ). The nonverbal communication may be used in affirming a direct communication and/or disaffirming the direct communication. Nonverbal communication is a common form of communication. For example, when a user becomes upset, the user's voice may become louder and/or change tone. The user's physical characteristics may also change. For example, a user's heart rate/breathing rate may increase/decrease, their facial expression, body movement, posture and the like may change depending on the situation (e.g. a user may lean forward to show attentiveness, show a look of disgust to show dissatisfaction, . . . ).

Vocal cue(s) 305 are nonverbal communications that are not the words themselves that are contained in a direct input. As discussed above, vocal cues comprise: Intonation (pitch) cues: level, range, and contours over time; Loudness (energy) cues: level, range, and contours over time; Duration pattern cues: timing of speech and silent regions, including latency pauses (time between machine actions and user's speech); and Voice quality cues: spectral and acoustic features of voice timbre (indicating vocal effort, tension, breathiness, roughness). Vocal cues 305 may include cues such as: tone, volume, inflections, culture-specific sounds, pacing of words, and the like. For example, monotone may indicate boredom, a slow rate of speech may indicate depression, a high voice and/or emphatic pitch may indicate enthusiasm, an ascending tone may indicate astonishment, a loud/terse voice may indicate anger, high pitch/spacing between words drawn out may indicate disbelief, and the like. The vocal cues may be used to determine psychological arousal, emotion, mood as well as whether a user is acting sarcastically, superior, and/or a submissive manner.

Heart rate 310 are nonverbal communications that may indicate a state of a user (e.g. excitement, tired, non-stressed, stressed, . . . ). Heart rate may be measured using different methods. For example, changes in skin color may be used and/or the heart rate may be monitored using one or more sensors. The heart rate may be kept within a user profile and/or during a user session. An elevated heart rate over the course of a session with a user may indicate the user's satisfaction level.

Breathing rate 315 may indicate different states for a user. For example, a user's breathing may indicate whether the user is telling the truth, if they are tired from an activity, and the like. The breathing cues detected may include whether: the breathing rate is fast, slow, high in chest to low in stomach, sighing, and the like.

Facial expression 320 includes detected cues based on the facial expression of a user(s). For example, mouth shape (e.g. smiling, frowning), squinting, and the like may be detected, blinking, lip movement, eyebrow movement, lip biting, skin color changing, showing tongue, and the like. The position of the eyes may also be detected (e.g. up and to the right/left, midline and left/right, down and right/left). While people can learn to manipulate some expressions (e.g. a smile), many unconscious facial expressions (lip-pout, tense-mouth, and tongue-show) may reflect true feelings and hidden attitudes of the user.

Body language 325 such as a user's posture, body movements is detected. Body language may indicate a subtle communication as well as non-subtle communications. The body language may indicate an emotional state as well as a physical state and/or mental state. The detected body language may include cues such as: facial expressions 320, posture (e.g. leaning forward, backward), gestures (e.g. nodding head), head position (tilt, leaning, other changes), tension in upper body, shoulder position (raising, lowering), body movement (e.g. fidgeting, flailing, crossing arms/legs, . . . ), eye contact, eye position, smiling, fro and the like. More than one cue may be detected. The shoulder-shrug is considered a sign of resignation, uncertainty, and submissiveness. The shrug cues may modify, counteract, or contradict verbal remarks. For example, when a user states “Yes, I'm sure,” along with lifting the shoulders suggests that the user might actually be saying “I'm not so sure.” A shrug may reveal misleading, ambiguous, or uncertain areas in dialogue and oral testimony.

Other nonverbal communication cues 330 may also be detected and used in determining an action to perform.

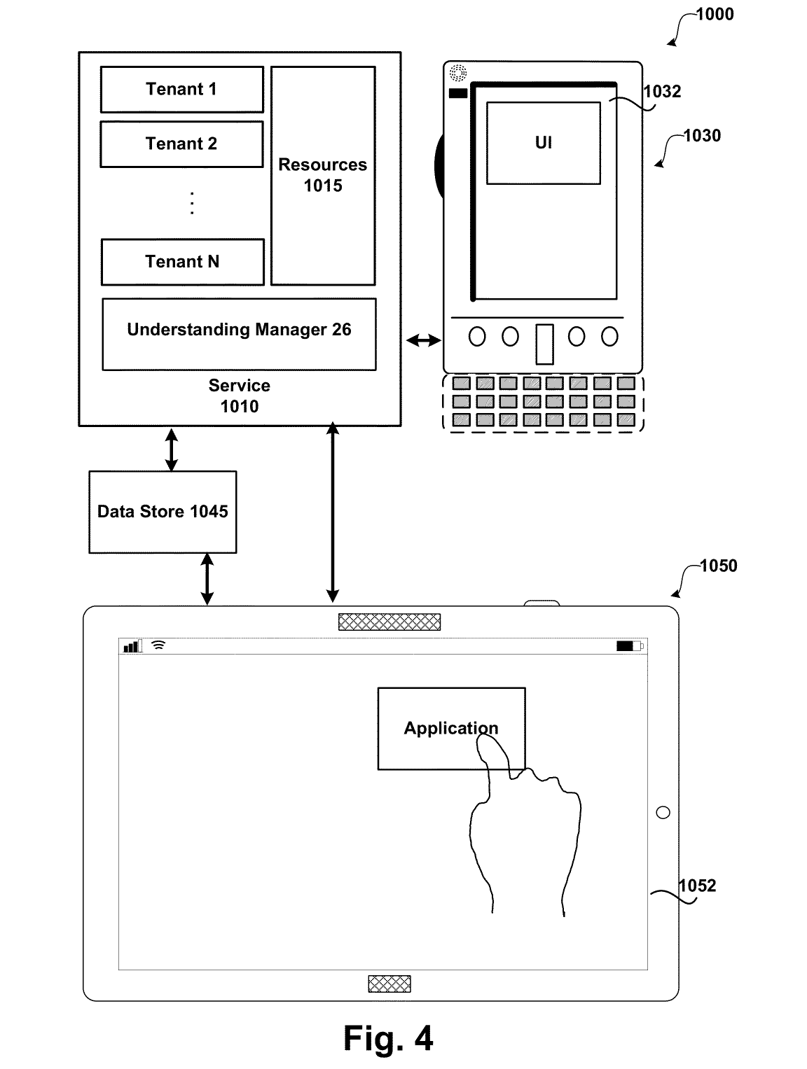

FIG. 4 illustrates an exemplary system for using nonverbal communication. As illustrated, system 1000 includes service 1010, data store 1045, touch screen input device/display 1050 (e.g. a slate) and smart phone 1030.

As illustrated, service 1010 is a cloud based and/or enterprise based service that may be configured to provide services, such as gaming services, search services, electronic messaging services (e.g. MICROSOFT EXCHANGE/OUTLOOK), productivity services (e.g. MICROSOFT OFFICE 365 or some other cloud based/online service that is used to interact with messages and content (e.g. spreadsheets, documents, presentations, charts, messages, and the like). The service may be interacted with using different types of input/output. For example, a user may use speech, gestures, touch input, hardware based input, speech input, and the like. The service may provide speech output that combines pre-recorded speech and synthesized speech. Functionality of one or more of the services/applications provided by service 1010 may also be configured as a client/server based application. Although system 1000 shows a service relating to a conversational understanding system, other services/applications may be configured.

As illustrated, service 1010 is a multi-tenant service that provides resources 1015 and services to any number of tenants (e.g. Tenants 1-N). Multi-tenant service 1010 is a cloud based service that provides resources/services 1015 to tenants subscribed to the service and maintains each tenant's data separately and protected from other tenant data.

System 1000 as illustrated comprises a touch screen input device/display 1050 (e.g. a slate/tablet device) and smart phone 1030 that detects when a touch input has been received (e.g. a finger touching or nearly touching the touch screen). Any type of touch screen may be utilized that detects a user's touch input. For example, the touch screen may include one or more layers of capacitive material that detects the touch input. Other sensors may be used in addition to or in place of the capacitive material. For example, Infrared (IR) sensors may be used. According to an embodiment, the touch screen is configured to detect objects that in contact with or above a touchable surface. Although the term “above” is used in this description, it should be understood that the orientation of the touch panel system is irrelevant. The term “above” is intended to be applicable to all such orientations. The touch screen may be configured to determine locations of where touch input is received (e.g. a starting point, intermediate points and an ending point). Actual contact between the touchable surface and the object may be detected by any suitable means, including, for example, by a vibration sensor or microphone coupled to the touch panel. A non-exhaustive list of examples for sensors to detect contact includes pressure-based mechanisms, micro-machined accelerometers, piezoelectric devices, capacitive sensors, resistive sensors, inductive sensors, laser vibrometers, and LED vibrometers.

Smart phone 1030 and device/display 1050 are also configured with other input sensing devices as described herein (e.g. microphone(s), camera(s), motion sensing device(s)). According to an embodiment, smart phone 1030 and touch screen input device/display 1050 are configured with applications that receive speech input.

As illustrated, touch screen input device/display 1050 and smart phone 1030 shows exemplary displays 1052/1032 showing the use of an application and performing actions determined using direct input and indirect input (nonverbal communication). Data may be stored on a device (e.g. smart phone 1030, slate 1050 and/or at some other location (e.g. network data store 1045). The applications used by the devices may be client based applications, server based applications, cloud based applications and/or some combination.

Understanding manager 26 is configured to perform operations relating to using nonverbal communications in determining actions to perform as described herein. While manager 26 is shown within service 1010, the functionality of the manager may be included in other locations (e.g. on smart phone 1030 and/or slate device 1050).

The embodiments and functionalities described herein may operate via a multitude of computing systems, including wired and wireless computing systems, mobile computing systems (e.g., mobile telephones, tablet or slate type computers, laptop computers, etc.). In addition, the embodiments and functionalities described herein may operate over distributed systems, where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

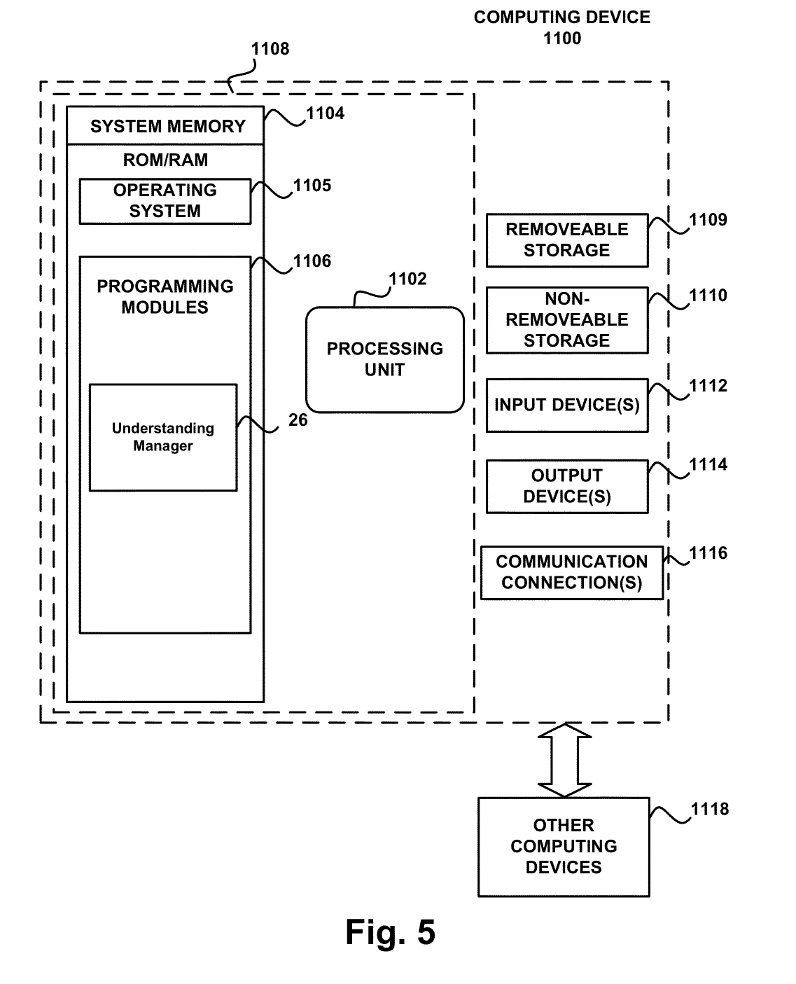

FIGS. 5-7 and the associated descriptions provide a discussion of a variety of operating environments in which embodiments of the invention may be practiced. However, the devices and systems illustrated and discussed with respect to these figures are for purposes of example and illustration and are not limiting of a vast number of computing device configurations that may be utilized for practicing embodiments of the invention, described herein.

FIG. 5 is a block diagram illustrating example physical components of a computing device 1100 with which embodiments of the invention may be practiced. The computing device components described below may be suitable for the computing devices described above. In a basic configuration, computing device 1100 may include at least one processing unit 1102 and a system memory 1104. Depending on the configuration and type of computing device, system memory 1104 may comprise, but is not limited to, volatile (e.g. random access memory (RAM)), non-volatile (e.g. read-only memory (ROM)), flash memory, or any combination. System memory 1104 may include operating system 1105, one or more programming modules 1106, and may include a web browser application 1120. Operating system 1105, for example, may be suitable for controlling computing device 1100's operation. In one embodiment, programming modules 1106 may include a understanding manager 26, as described above, installed on computing device 1100. Furthermore, embodiments of the invention may be practiced in conjunction with a graphics library, other operating systems, or any other application program and is not limited to any particular application or system. This basic configuration is illustrated in FIG. 5 by those components within a dashed line 1108.

Computing device 1100 may have additional features or functionality. For example, computing device 1100 may also include additional data storage devices (removable and/or non-removable) such as, for example, magnetic disks, optical disks, or tape. Such additional storage is illustrated by a removable storage 1109 and a non-removable storage 1110.

As stated above, a number of program modules and data files may be stored in system memory 1104, including operating system 1105. While executing on processing unit 1102, programming modules 1106, such as the manager may perform processes including, for example, operations related to methods as described above. The aforementioned process is an example, and processing unit 1102 may perform other processes. Other programming modules that may be used in accordance with embodiments of the present invention may include game applications, search applications, electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. For example, embodiments of the invention may be practiced via a system-on-a-chip (SOC) where each or many of the components illustrated in FIG. 5 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the manager 26 may be operated via application-specific logic integrated with other components of the computing device/system 1100 on the single integrated circuit (chip). Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process.

The term computer readable media as used herein may include computer storage media. Computer storage media may include volatile and nonvolatile, removable and non-removable media implemented in any method or technology for storage of information, such as computer readable instructions, data structures, program modules, or other data. System memory 1104, removable storage 1109, and non-removable storage 1110 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1100. Any such computer storage media may be part of device 1100. Computing device 1100 may also have input device(s) 1112 such as a keyboard, a mouse, a pen, a sound input device, a touch input device, etc. Output device(s) 1114 such as a display, speakers, a printer, etc. may also be included. The aforementioned devices are examples and others may be used.

A camera and/or some other sensing device may be operative to record one or more users and capture motions and/or gestures made by users of a computing device. Sensing device may be further operative to capture spoken words, such as by a microphone and/or capture other inputs from a user such as by a keyboard and/or mouse (not pictured). The sensing device may comprise any motion detection device capable of detecting the movement of a user. For example, a camera may comprise a MICROSOFT KINECT® motion capture device comprising a plurality of cameras and a plurality of microphones.

The term computer readable media as used herein may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

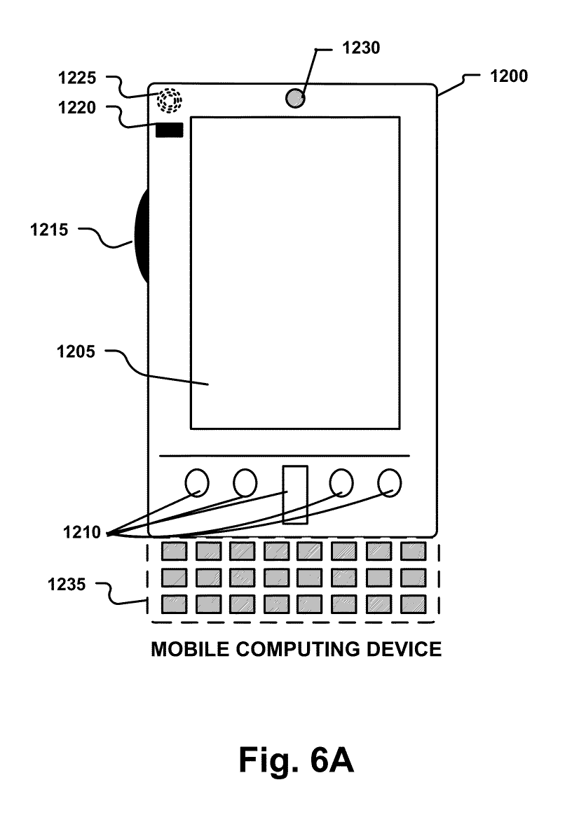

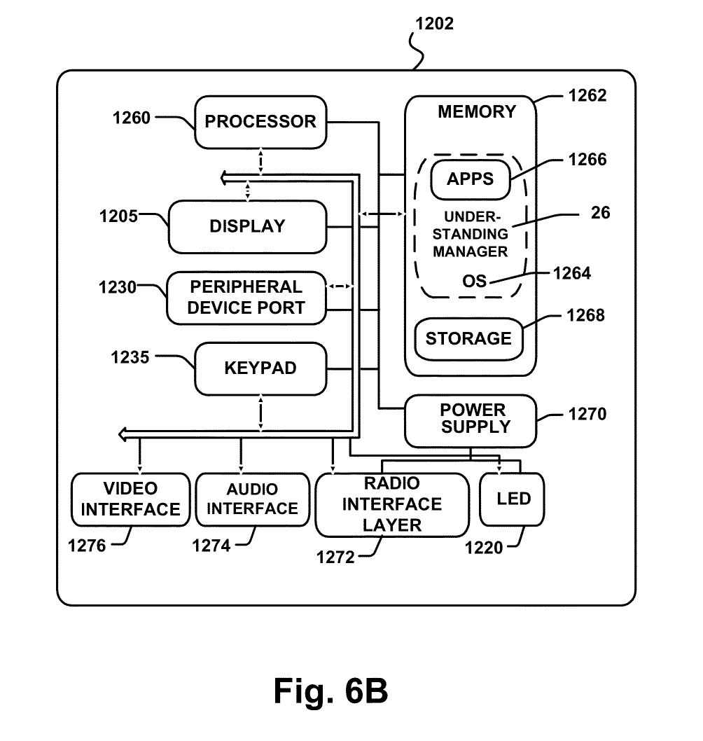

FIGS. 6A and 6B illustrate a suitable mobile computing environment, for example, a mobile telephone, a smartphone, a tablet personal computer, a laptop computer, and the like, with which embodiments of the invention may be practiced. With reference to FIG. 6A, an example mobile computing device 1200 for implementing the embodiments is illustrated. In a basic configuration, mobile computing device 1200 is a handheld computer having both input elements and output elements. Input elements may include touch screen display 1205 and input buttons 1215 that allow the user to enter information into mobile computing device 1200. Mobile computing device 1200 may also incorporate an optional side input element 1215 allowing further user input. Optional side input element 1215 may be a rotary switch, a button, or any other type of manual input element. In alternative embodiments, mobile computing device 1200 may incorporate more or less input elements. For example, display 1205 may not be a touch screen in some embodiments. In yet another alternative embodiment, the mobile computing device is a portable phone system, such as a cellular phone having display 1205 and input buttons 1215. Mobile computing device 1200 may also include an optional keypad 1235. Optional keypad 1215 may be a physical keypad or a “soft” keypad generated on the touch screen display.

Mobile computing device 1200 incorporates output elements, such as display 1205, which can display a graphical user interface (GUI). Other output elements include speaker 1225 and LED light 1220. Additionally, mobile computing device 1200 may incorporate a vibration module (not shown), which causes mobile computing device 1200 to vibrate to notify the user of an event. In yet another embodiment, mobile computing device 1200 may incorporate a headphone jack (not shown) for providing another means of providing output signals.

Although described herein in combination with mobile computing device 1200, in alternative embodiments the invention is used in combination with any number of computer systems, such as in desktop environments, laptop or notebook computer systems, multiprocessor systems, micro-processor based or programmable consumer electronics, network PCs, mini computers, main frame computers and the like. Embodiments of the invention may also be practiced in distributed computing environments where tasks are performed by remote processing devices that are linked through a communications network in a distributed computing environment; programs may be located in both local and remote memory storage devices. To summarize, any computer system having a plurality of environment sensors, a plurality of output elements to provide notifications to a user and a plurality of notification event types may incorporate embodiments of the present invention.

FIG. 6B is a block diagram illustrating components of a mobile computing device used in one embodiment, such as the computing device shown in FIG. 6A. That is, mobile computing device 1200 can incorporate system 1202 to implement some embodiments. For example, system 1202 can be used in implementing a “smart phone” that can run one or more applications similar to those of a desktop or notebook computer such as, for example, presentation applications, browser, e-mail, scheduling, instant messaging, and media player applications. In some embodiments, system 1202 is integrated as a computing device, such as an integrated personal digital assistant (PDA) and wireless phoneme.

One or more application programs 1266 may be loaded into memory 1262 and run on or in association with operating system 1264. Examples of application programs include phone dialer programs, e-mail programs, PIM (personal information management) programs, word processing programs, spreadsheet programs, Internet browser programs, messaging programs, and so forth. System 1202 also includes non-volatile storage 1268 within memory 1262. Non-volatile storage 1268 may be used to store persistent information that should not be lost if system 1202 is powered down. Applications 1266 may use and store information in non-volatile storage 1268, such as e-mail or other messages used by an e-mail application, and the like. A synchronization application (not shown) may also reside on system 1202 and is programmed to interact with a corresponding synchronization application resident on a host computer to keep the information stored in non-volatile storage 1268 synchronized with corresponding information stored at the host computer. As should be appreciated, other applications may be loaded into memory 1262 and run on the device 1200, including the understanding manager 26, described above.

System 1202 has a power supply 1270, which may be implemented as one or more batteries. Power supply 1270 might further include an external power source, such as an AC adapter or a powered docking cradle that supplements or recharges the batteries.

System 1202 may also include a radio 1272 that performs the function of transmitting and receiving radio frequency communications. Radio 1272 facilitates wireless connectivity between system 1202 and the “outside world”, via a communications carrier or service provider. Transmissions to and from radio 1272 are conducted under control of OS 1264. In other words, communications received by radio 1272 may be disseminated to application programs 1266 via OS 1264, and vice versa.

Radio 1272 allows system 1202 to communicate with other computing devices, such as over a network. Radio 1272 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

This embodiment of system 1202 is shown with two types of notification output devices; LED 1220 that can be used to provide visual notifications and an audio interface 1274 that can be used with speaker 1225 to provide audio notifications. These devices may be directly coupled to power supply 1270 so that when activated, they remain on for a duration dictated by the notification mechanism even though processor 1260 and other components might shut down for conserving battery power. LED 1220 may be programmed to remain on indefinitely until the user takes action to indicate the powered-on status of the device. Audio interface 1274 is used to provide audible signals to and receive audible signals from the user. For example, in addition to being coupled to speaker 1225, audio interface 1274 may also be coupled to a microphone 1220 to receive audible input, such as to facilitate a telephone conversation. In accordance with embodiments of the present invention, the microphone 1220 may also serve as an audio sensor to facilitate control of notifications, as will be described below. System 1202 may further include video interface 1276 that enables an operation of on-board camera 1230 to record still images, video stream, and the like.

A mobile computing device implementing system 1202 may have additional features or functionality. For example, the device may also include additional data storage devices (removable and/or non-removable) such as, magnetic disks, optical disks, or tape. Such additional storage is illustrated in FIG. 8B by storage 1268. Computer storage media may include volatile and nonvolatile, removable and non-removable media implemented in any method or technology for storage of information, such as computer readable instructions, data structures, program modules, or other data.

Data/information generated or captured by the device 1200 and stored via the system 1202 may be stored locally on the device 1200, as described above, or the data may be stored on any number of storage media that may be accessed by the device via the radio 1272 or via a wired connection between the device 1200 and a separate computing device associated with the device 1200, for example, a server computer in a distributed computing network such as the Internet. As should be appreciated such data/information may be accessed via the device 1200 via the radio 1272 or via a distributed computing network. Similarly, such data/information may be readily transferred between computing devices for storage and use according to well-known data/information transfer and storage means, including electronic mail and collaborative data/information sharing systems.

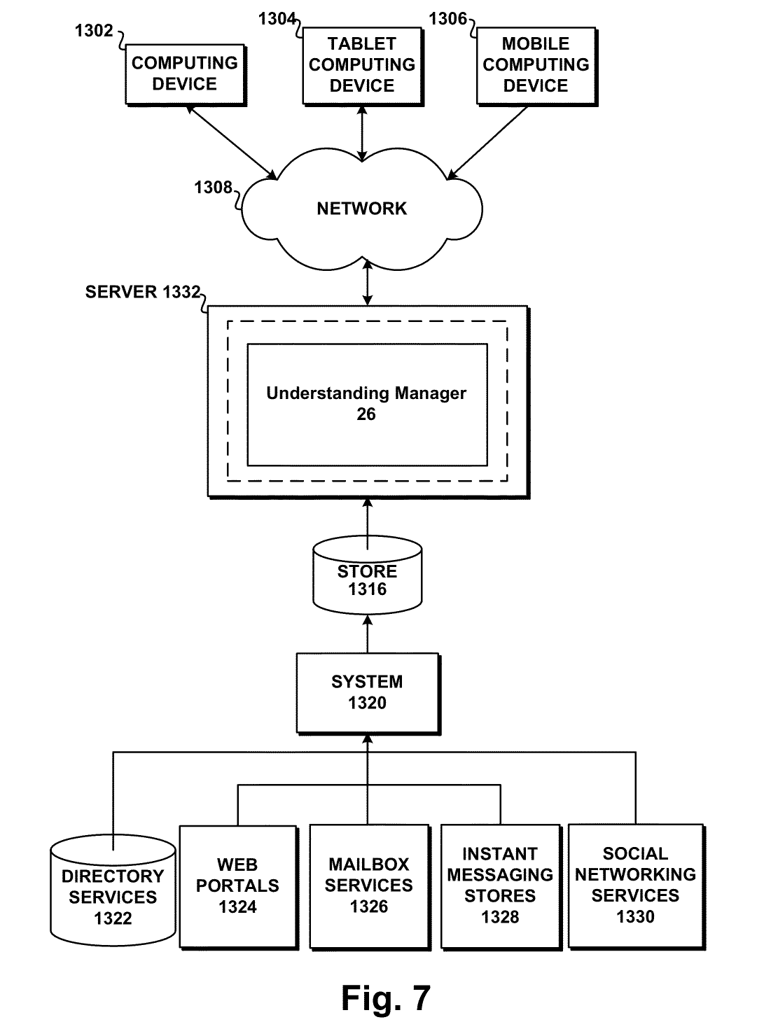

FIG. 7 illustrates a system architecture for recommending items used during composition of a message item.

Components managed via the understanding manager 26 may be stored in different communication channels or other storage types. For example, components along with information from which they are developed may be stored using directory services 1322, web portals 1324, mailbox services 1326, instant messaging stores 1328 and social networking sites 1330. The systems/applications 26, 1320 may use any of these types of systems or the like for enabling management and storage of components in a store 1316. A server 1332 may provide communications and services relating to recommending items. Server 1332 may provide services and content over the web to clients through a network 1308. Examples of clients that may utilize server 1332 include computing device 1302, which may include any general purpose personal computer, a tablet computing device 1304 and/or mobile computing device 1306 which may include smart phones. Any of these devices may obtain display component management communications and content from the store 1316.

Embodiments of the present invention are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for using nonverbal communication to determine an intended action, comprising:
receiving user interaction comprising direct input specifying an intended action and indirect input comprising nonverbal communication;
determining the direct input using at least one of: speech input, gesture input, and textual input;
determining the indirect input comprising the nonverbal communication;
using the indirect communication in addition to the intended action determined from the direct input to determine an action to perform; and
performing the action.

2. The method of claim 1, further comprising determining a user satisfaction using received nonverbal communication after performing the action.

3. The method of claim 1, further comprising performing an additional action in response to determining a user satisfaction using received nonverbal communication after performing the action.

4. The method of claim 3, wherein performing the additional action in response to determining the user satisfaction comprises requesting a clarification to the intended action.

5. The method of claim 1, wherein performing the additional action in response to determining the user satisfaction comprises changing content displayed on a user interface.

6. The method of claim 1, wherein determining the user satisfaction using received nonverbal communication after performing the action comprises determining a facial expression.

7. The method of claim 1, wherein the nonverbal communication comprises a voice cue comprising one or more of: a voice level, a spacing of speech, and a rate of speech.

8. The method of claim 1, further comprising accessing a profile of a user associated with the input that includes nonverbal communication information that is associated with the user.

9. The method of claim 1, wherein the nonverbal communication comprises one or more of: a vocal cue, a heart rate, a breathing rate, a facial expression, a body movement, and a posture.

10. A computer-readable medium storing computer-executable instructions for using nonverbal communication, comprising:
receiving user interaction comprising direct input specifying an intended action and indirect input comprising nonverbal communication;
determining the direct input using at least one of: speech input, gesture input, and textual input;
determining the indirect input comprising the nonverbal communication that comprises one or more of: a vocal cue, a heart rate, a breathing rate, a facial expression, a body movement, and a posture;
accessing a profile that includes information relating to a baseline of nonverbal communication cues associated with a user;
determining changes from the baseline using the determined indirect communication;
using the indirect communication and determined changes in addition to the intended action determined from the direct input to determine an action to perform; and
performing the action.

11. The computer-readable medium of claim 10, further comprising determining a user satisfaction using received nonverbal communication after performing the action.

12. The computer-readable medium of claim 10, further comprising performing an additional action in response to determining a user satisfaction using received nonverbal communication after performing the action.

13. The computer-readable medium of claim 12, wherein performing the additional action in response to determining the user satisfaction comprises requesting a clarification to the intended action.

14. The computer-readable medium of claim 10, wherein performing the additional action in response to determining the user satisfaction comprises changing content displayed on a user interface.

15. The computer-readable medium of claim 10, wherein determining the user satisfaction using received nonverbal communication after performing the action comprises determining a facial expression.

16. The computer-readable medium of claim 10, wherein the nonverbal communication comprises a voice cue comprising one or more of: a voice level, a spacing of speech, and a rate of speech.

17. A system for using nonverbal communication, comprising:
a camera that is configured to detect movements;
a microphone that is configured to receive speech input;
a processor and memory;
an operating environment executing using the processor;
a display; and
an understanding manager that is configured to perform actions comprising:
receiving user interaction comprising direct input specifying an intended action and indirect input comprising nonverbal communication;
determining the direct input using at least one of: speech input, gesture input, and textual input;
determining the indirect input comprising the nonverbal communication that comprises one or more of: a vocal cue, a heart rate, a breathing rate, a facial expression, a body movement, and a posture;
accessing a profile that includes information relating to a baseline of nonverbal communication cues associated with a user;
determining changes from the baseline using the determined indirect communication;
using the indirect communication and determined changes in addition to the intended action determined from the direct input to determine an action to perform; and
performing the action.

18. The system of claim 17, further comprising determining a user satisfaction using received nonverbal communication after performing the action and performing an additional action in response to determining a user satisfaction using received nonverbal communication after performing the action.

19. The system of claim 17, wherein determining the user satisfaction using received nonverbal communication after performing the action comprises determining a facial expression.

20. The system of claim 17, wherein the nonverbal communication comprises a voice cue comprising one or more of: a voice level, a spacing of speech, and a rate of speech.
